(19) United States
(12) Patent Application Publication
(10) Pub. No.: US 2006/0039767 A1
(43) Pub. Date: Feb. 23, 2006

(54) Carbide drill capable of drilling hole with reduced degree of work hardening

(75) Inventors: Takahiro Yamamoto, Toyokawa-shi (JP); Jiro Osawa, Toyokawa-shi (JP)

Correspondence Address: OLIFF & BERRIDGE, PLC, P.O. BOX 19928, ALEXANDRIA, VA, 22320, US

(73) Assignee: OSG CORPORATION, Toyokawa-shi (JP)

(21) Appl. No.: 11/174,652

(22) Filed: Jul. 6, 2005

(30) Foreign Application Priority Data
Aug. 23, 2004 (JP) 2004-242446

(51) Int. Cl. B23B 51/02

(52) U.S. Cl. 408/230

(57) ABSTRACT

A drill including flutes formed therein and extending from an axially distal end portion thereof toward an axially proximal end portion thereof, so as to provide cutting edges in the axially distal end portion which is formed of cemented carbide. The cutting edges cooperate with each other to define a point angle of the drill that is not smaller than 125° and is not larger than 135°. Each of the flutes is twisted by a helix angle that is not smaller than 20° and is not larger than 30°. Each of the cutting edges has a radially inner end portion which is formed in a web thinning, such that an axial rake angle of the radially inner end portion of each of the cutting edges is not smaller than −5° and is not larger than +5°.

### BACKGROUND OF THE INVENTION

1. Field of the Invention

The present invention relates in general to a carbide drill, and more particularly to such a carbide drill capable of drilling a hole in a workpiece without considerably hardening the workpiece.

There is known a carbide drill, as disclosed in JP-A-2001-300808 (publication of Japanese Patent Application laid open in 2001), which is formed of cemented carbide. In general, such a carbide drill is given a point angle of about 140° and is formed with chip evacuation flutes twisted by a helix angle of about 30°, for example, where the drill is designed to drill a hole in a hub of a motor vehicle.

However, in a drilling operation in which the drill is inevitably brought into contact at its margins or leading edges with an inner circumferential surface of the drilled hole, the inner circumferential surface of the hole could be hardened by heat generated due to its frictional contact with the drill. Such a work-hardening tendency is notable where the workpiece is formed of a high carbon steel or other material which is easily hardened. For example, where the workpiece is formed of S55C whose hardness is about 300 HV, for providing a hub of a motor vehicle, the hardness of the workpiece could be increased to 750 HV or more at the inner circumferential surface of the drilled hole. Where the drilled hole is subjected to further machining operation such as finishing and internal threading, the work hardening leads to a reduced tool life of a finishing tool such as reamer or a threading tool such as tap. Further, where a bolt, pin or the like is intended to be press-fitted into the drilled hole, the work hardening could make it impossible to carry out such a press-fitting operation. The degree of the work hardening is ignorably small when the hole is drilled by a new drill maintaining its original shape. However, it becomes problematically large after the drill has been worn or chipped, particularly, at its corner edges, i.e., radial corners at which the cutting edges and the leading edges intersect with each other.

### SUMMARY OF THE INVENTION

The present invention was made in view of the background prior art discussed above. It is therefore an object of the invention to provide a carbide drill capable of drilling a hole in a workpiece without considerably hardening the workpiece even where the workpiece is formed of a high carbon steel or other material which is easily hardened. This object may be achieved according to any one of first through fourth aspects of the invention which are described below.

The first aspect of the invention provides a drill including flutes formed therein and extending from an axially distal end portion thereof toward an axially proximal end portion thereof, so as to provide cutting edges in the axially distal end portion, wherein at least the axially distal end portion is formed of cemented carbide. The cutting edges cooperate with each other to define a point angle of the drill that is not smaller than 125° and is not larger than 135°. Each of the flutes is twisted by a helix angle that is not smaller than 20° and is not larger than 30°. Each of the cutting edges has a radially inner end portion which is formed in a web thinning, such that an axial rake angle of the radially inner end portion of each of the cutting edges is not smaller than −5° and is not larger than +5°.

The second aspect of the invention provides a drill which is to be rotated about an axis thereof in a predetermined rotating direction, for drilling a hole in a workpiece. The drill has (a) primary cutting edges and secondary cutting edges formed in an axially distal end portion thereof such that each of the secondary cutting edges is located on a radially inner side of a corresponding one of the primary cutting edges, (b) flutes each of which extends from the axially distal end portion toward an axially proximal end portion thereof, (c) primary rake surfaces each of which defines a corresponding one of the primary cutting edges; and (d) secondary rake surfaces each of which defines a corresponding one of the secondary cutting edges, such that each of the secondary rake surfaces is located on a radially inner side of a corresponding one of the primary rake surfaces, wherein at least the axially distal end portion is formed of cemented carbide. Each of the secondary rake surfaces and the corresponding one of the primary rake surfaces are provided by a longitudinally distal end portion of a rear side wall, as viewed in the predetermined rotating direction, of a corresponding one of the flutes. The primary and secondary cutting edges cooperate with each other to define a point angle of the drill that is not smaller than 125° and is not larger than 135° . Each of the flutes is twisted with respect to the axis by a helix angle that is not smaller than 20° and is not larger than 30°. Each of the secondary rake surfaces is recessed in such a direction that permits a web thickness in the axially distal end portion to be reduced, such that an axial rake angle of each of the secondary cutting edges is not smaller than −5° and is not larger than +5°.

According to the third aspect of the invention, in the drill defined in the first or second aspect of the invention, the cutting edges is chamfered so as to be provided with a negative land, such that the negative land has a width that is not smaller than 0.05 mm and is not larger than 0.15 mm.

According to the fourth aspect of the invention, the drill defined in any one of the first through third aspects of the invention, is at least partially coated with a hard coating.

In the carbide drill defined in any one of the first through fourth aspects of the invention, since the point angle is 125-135° and is accordingly smaller than the point angle of a conventional carbide drill which is about 140°, an angle of the radial corners (denoted by reference sign “θ” in FIG. 1) is made relatively large, thereby restraining occurrence of chipping of the radial corners and reducing wear at the radial corners. Further, since the point angle is not smaller than 125°, it is also possible to restraining occurrence of breakage or chipping of the radially inner end portion of each cutting edge (or each secondary cutting edge). Still further, since the helix angle is 20-30° while the axial rake angle of the radially inner end portion of each cutting edge (or each secondary cutting edge) ranges from −5° to +5°, the drill is advantageously given both high degrees of cutting sharpness and strength at the radial corners and the radially inner end portion of each cutting edge (or each secondary cutting edge), and is accordingly capable of performing a drill operation with an increased efficiency and a reduced risk of breakage or chipping. Therefore, the drill constructed according to the invention provides a high degree of machining accuracy over a large period of time, and avoids considerable increase of the friction of its margins or leading edges with the inner surface of the drilled hole, thereby restraining the work hardening caused by frictional heating.

In the carbide drill defined in the third aspect of the invention, since each of the cutting edges is chamfered by honing or the like, so as to be provided with the negative land which has a width of 0.05-015 mm, the cutting edge is given both a high degree of cutting sharpness and a high degree of strength. Therefore, the drill of the third aspect of the invention provides a high degree of machining accuracy over a still larger period of time, and further effectively avoids increase of its friction with the inner surface of the drilled hole, thereby further reliably restraining the work hardening caused by frictional heating.

The drill defined in any one of the first through fourth aspects of the invention is entirely or partially formed of the cemented carbide. Where the drill is entirely formed of the cemented carbide, not only its cylindrical main body but also its shank is formed of the cemented carbide. Where the drill is partially formed of the cemented carbide, its axially distal end portion or cylindrical main body is formed of the cemented carbide and is fixed to the other portion or shank (which is formed of other material such as high-speed steel) by suitable fixing means such as brazing and shrinkage fitting.

In the drill defined in any one of the first through fourth aspects of the invention, the point angle of the drill is 125-135°. If the point angle were larger than 135°, the angle of the radial corners would be made considerably small whereby the radial corners could be easily chipped or worn as a result of the reduced strength at the radial corners. If the point angle were smaller than 125°, each cutting edge could be easily broken or chipped at its axially distal end or radially inner end portion, or each secondary cutting edge could be easily broken or chipped.

In the drill defined in any one of the first through fourth aspects of the invention, the helix angle of the drill is 20-30°. If the helix angle were larger than 30°, the strength at the radial corners and cutting edges would be reduced whereby the radial corners and the cutting edges could be easily broken and chipped. If the helix angle were smaller than 20°, the degree of cutting sharpness would be reduced whereby the durability of the drill and the machining accuracy provided by the drill could be undesirably reduced.

In the drill defined in any one of the first through fourth aspects of the invention, the axial rake angle of the radially inner end portion of each cutting edge or the axial rake angle of each secondary cutting edge is not smaller than −5° and is not larger than +5°. If it were larger than +5°, the radially end portion of each cutting edge or each secondary cutting edge could be easily broken or chipped as a result of reduction in the strength thereof. If it were smaller than −5°, the degree of cutting sharpness of the radially end portion of each cutting edge or each secondary cutting edge would be reduced, whereby the cutting resistance acting on the drill and the machining accuracy provided by the drill could be undesirably increased and reduced, respectively.

In the drill defined in the third aspect of the invention, the negative land provided at each of the cutting edges has the width of 0.05-0.15 mm. If the width of the negative land were larger than 0.15 mm, the degree of cutting sharpness of each cutting edge would be reduced whereby the machining accuracy could be reduced. If the width of the negative land were smaller than 0.05 mm, each cutting edge could be easily broken or chipped as a result of reduction in the strength thereof. It is noted that the chamfering of each cutting edge or the formation of the negative land at each cutting edge is preferably made by honing or the like.

The drill of the invention may be entirely or partially coated with the hard coating, as needed, like in the fourth aspect of the invention. The hard coating may be formed of TiAlN or the like.

### BRIEF DESCRIPTION OF THE DRAWINGS

The above and other objects, features, advantages and technical and industrial significance of this invention will be better understood by reading the following detailed description of the presently preferred embodiment of the invention, when considered in connection with the accompanying drawings, in which:

FIG. 1 is a set of views showing an axially distal end portion of a carbide drill constructed according to an embodiment of the invention;

FIG. 2 is a front view of the axially distal end portion of the drill of FIG. 1;

FIG. 3 is a cross sectional view of the drill of FIG. 1, for explaining a negative land which is formed at each cutting edge by a honing operation;

FIG. 4 is a table showing a result of a test which was conducted to confirm the durability of each of drills as trial products and the amount of work hardening caused by a drilling operation performed by each drill; and

FIG. 5 is a graph representative of a relationship between the amount of increase in the hardness in the “FINAL STAGE” and the number of the drilled holes in the drilling operation performed by each drill shown in the table of FIG. 4.

### DETAILED DESCRIPTION OF THE PREFERRED EMBODIMENT

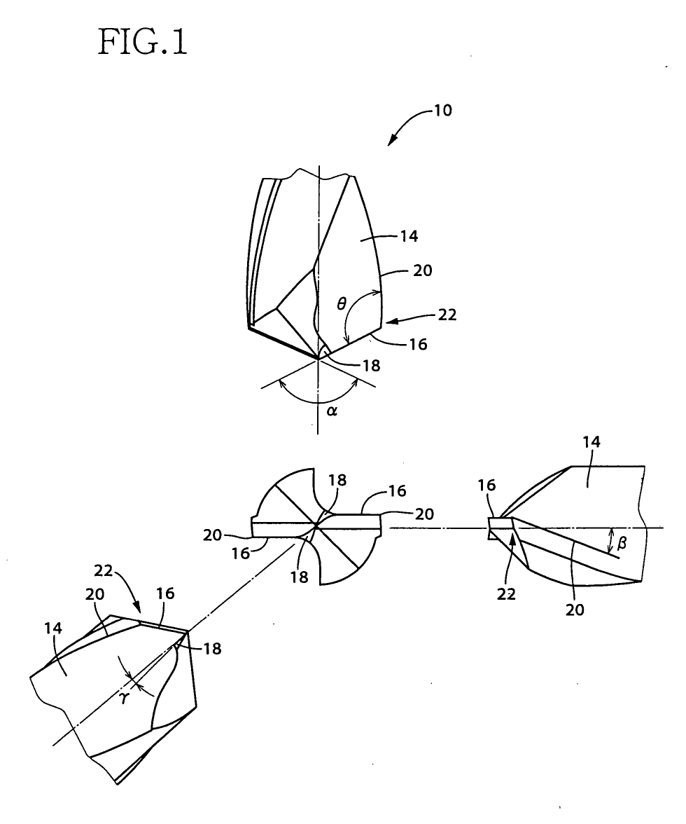

FIG. 1 is a set of views showing an axially distal end portion of a carbide drill 10 constructed according to an embodiment of the invention, wherein a central one of the views is a front view as seen in an axial direction of the drill 10 while the other three views surrounding the central view are side views as seen in respective directions perpendicular to the axial direction. This carbide drill 10 is entirely formed of cemented carbide, and has a pair of chip evacuation flutes 14 formed in its outer circumferential surface and extending from its axially distal end portion toward its axially proximal end portion, so that a pair of cutting edges 16 are provided in the axial distal end portion of the carbide drill 10 while each of a pair of leading edges 20 is provided by a rear-side one of widthwise opposite edges of a corresponding one of the flutes 14 as viewed in a rotating direction of the drill 10.

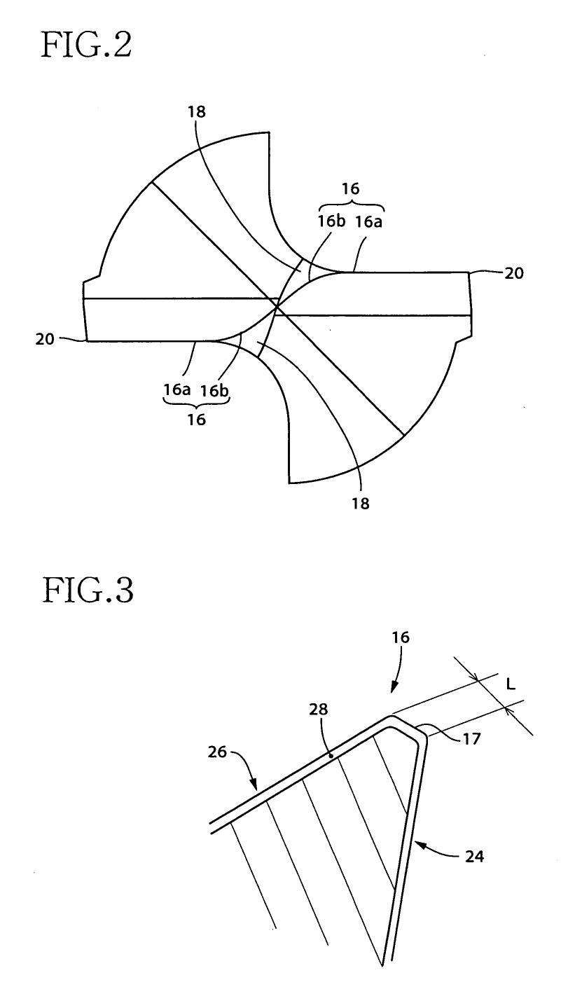

Each of the cutting edges 16 consists of a primary cutting edge 16a and a secondary cutting edge 16b which is located on a radially inner side of the primary cutting edge 16a, as best shown in FIG. 2. Each of the flutes 14 provides a rake surface 24 in a longitudinally distal end portion of a rear-side one of its widthwise opposite side walls as viewed in the rotating direction of the drill 10. The rake surface 24 consists of a primary rake surface and a secondary rake surface which is located on a radially inner side of the primary rake surface, such that the primary rake surface defines the primary cutting edge 16a while the secondary rake surface defines the secondary cutting edge 16b. The secondary rake surface is recessed in such a direction that permits a web thickness in the axially distal end portion to be reduced, such that the secondary cutting edge 16b defined by the thus recessed secondary rake surface extends substantially up to an axis of the drill 10 and is curved so as to be convexed forwardly as viewed in the rotating direction of the drill 10. A reference sign 18 denotes a portion of a web which is thinned by thus recessing the secondary rake surface. Each of the cutting edges 16 is chamfered by honing, so as to be formed with a negative land 17 as shown in FIG. 3. It is noted that the above-described secondary cutting edge may be referred also to as a radially inner end portion of each of the cutting edges 16. It is also noted that the drill 10 consists of a cylindrical main body which is formed with the chip evacuation flutes 14 and a shank (not shown) which is contiguous to the cylindrical main body. The above-described axially distal end portion of the drill 10 is provided by an end portion of the cylindrical main body, while the above-described axially proximal end portion of the drill 10 is provided by an end portion of the shank.

The pair of cutting edges 16 cooperate with each other of define a point angle a of the drill 10 that is not smaller than 125° and is not larger than 135°. Each of the flutes 14 is twisted by a helix angle β that is not smaller than 20° and is not larger than 30°. Each of the secondary cutting edges 16b, which are formed in the web thinning, is given an axial rake angle γ that is not smaller than −5° and is not larger than +5°. The negative land 17, which is formed at each cutting edge 16 by the honing, has a width L that is not smaller than 0.05 mm and is not larger than 0.15 mm.

The axial rake angle γ of the secondary cutting edge 16b is an angel between the secondary rake surface (which defines the secondary cutting edge 16b) and a line parallel with the axis of the drill 10. FIG. 1 illustrates a case where the axial rake angle γ of the secondary cutting edge 16b has a negative value (γ<0) rather than a positive value. The width L of the negative land 17 corresponds to a width of a generally flat portion which is formed by the honing, at each cutting edge 16, i.e., at an intersection between the rake surface 24 and a flank surface 26 that is located on a rear side of the rake surface 24 as viewed in the rotating direction, as shown in FIG. 3 which is a cross sectional view taken in a plane perpendicular to the cutting edge 16. It is noted that the drill 10 is coated at its surface with a hard coating 28 (formed of TiAlN or the like) after the negative land 17 is formed by the honing. The above-described value of the width L of the negative land 17 is a value as measured after the drill 10 is coated with the hard coating 28.

In the carbide drill 10 constructed as described above, since the point angle α is 125-135° and is accordingly smaller than the point angle of a conventional carbide drill which is about 140°, an angle θ of radial corners 22 (at each of which the cutting edge 16 and leading edge 20 intersect each other) is made relatively large, thereby restraining occurrence of chipping of the radial corners 22 and reducing wear at the radial corners 22. Further, since the point angle α is not smaller than 125°, it is also possible to restraining occurrence of breakage or chipping of the secondary cutting edge 16b. Still further, since the helix angle β is 20-30° while the axial rake angle γ of each secondary cutting edge 16b ranges from −5° to +5°, the drill 10 is advantageously given both high degrees of cutting sharpness and strength at the radial corners 22 and the secondary cutting edge 16b, and is accordingly capable of performing a drill operation with an increased efficiency and a reduced risk of breakage or chipping. Still further, since the negative land 17 (which is formed at the cutting edge 16 by the honing) has the width L of 0.05-0.15 mm, the cutting edge 16 in its entirety is given both a high degree of cutting sharpness and a high degree of strength. Therefore, the drill 10 provides a high degree of machining accuracy over a large period of time, and avoids considerable increase of the friction of its margins or leading edges with the inner surface of the drilled hole, thereby restraining the work hardening caused by frictional heating.

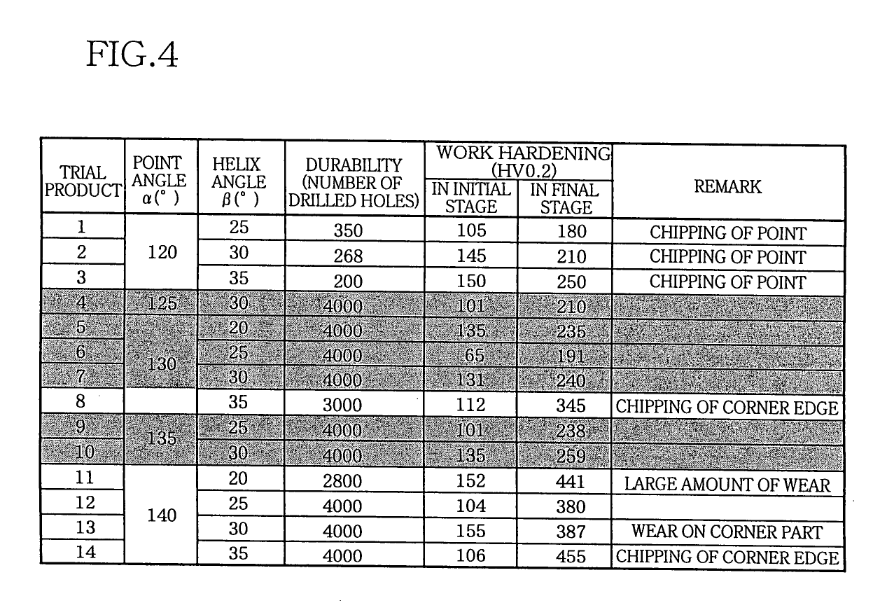

There will be next described a test which was conducted for further clarifying technical advantages provided by the present invention. In this test, drilling operations were carried out by using trial products in the form of drills Nos. 1-14 as indicated in table of FIG. 4, for checking the durability of each drill and the degree of work hardening under a cutting condition as described below. Among the used drills Nos. 1-14, six drills Nos. 4-7, 9 and 10 are what were constructed according to the invention, while the other drills Nos. 1-3, 8 and 11-14 are comparative examples. The drills Nos. 1-14 have respective point angles a and helix angles β, as indicated in table of FIG. 4, but have the same axial rake angle γ(=0°) of the secondary cutting edge 16b and the same width L (=0.10 mm) of the negative land 17 formed at the cutting edge 16 by the honing.

Cutting Condition

Workpiece material: S55C (carbon steel)
Depth of drilled hole (through-hole): 11 mm
Diameter of drilled hole: 10.8 mm
Cutting speed (peripheral speed): 70 m/min
Feed rate: 0.25 mm/rev

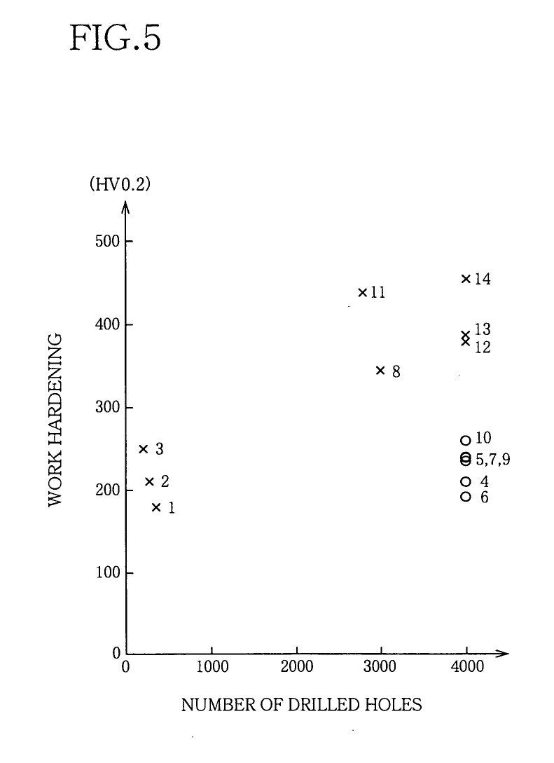

In the test, the drilling operation by each of the drills Nos. 1-14 was continued until a predetermined number of holes (a total of 4000 holes) had been drilled by the drill, or until the drill had become incapable for continuing the drilling operation. In column of “DURABILITY” in the table of FIG. 4, the number of holes successively formed by each of the drills Nos. 1-14 is indicated. All of the above-described six drills Nos. 4-7, 9 and 10 were capable of drilling the predetermined number of holes, while some of the above-described other drills as the comparative examples became incapable due to excessive amount of wear or chipping (as specified in column of “REMARKS”) before completing the predetermined number of holes. In column of “WORK HARDENING (HV0.2)” in the table, an amount of increase in hardness of the machined workpiece in the drilling operation by each of the drills Nos. 1-14 is indicated. The amount of increase in the hardness was measured through Vickers hardness test. Specifically described, a hardness “X” at a machined surface of the machined workpiece (i.e., at an inner circumferential surface of the drilled hole) was first measured with a load of 1.96 N (200 gf), and then a hardness “Y” at an inner portion underlying a hardened surface layer of the machined workpiece was measured with the same load, after removing the hardened surface layer from the workpiece. That is, the amount of increase in the hardness corresponds to a value (X−Y) that is obtained by subtracting “Y” from “X”. In the table, “INITIAL STAGE” indicates the amount of increase in the hardness that was measured in an initial stage of the drilling operation by each drill. “FINAL STAGE” indicates the amount of increase in the hardness that was measured in the 4000th hole or in the final hole drilled just before the drill became incapable. FIG. 5 is a graph represents a relationship between the amount of increase in the hardness in the “FINAL STAGE” and the number of the drilled holes (durability) in the drilling operation performed by each of the drills Nos. 1-14. In this graph, “◯” means that the corresponding drill is what was constructed according to the invention, while “X” means that the corresponding drill is one of the above-described comparative examples. Each number accompanying “◯” or “X” represents the number of the corresponding drill as the trial product.

As is apparent from FIGS. 4 and 5, all of the drills constructed according to the invention were capable of drilling the predetermined number (=4000) of holes without suffering from wear or chipping. As to the amount of increase in the hardness, there was a remarkable difference between the drills of the invention and the comparative examples in the “FINAL STAGE”, although there was not such a large difference therebetween in the “INITIAL STAGE”. Described specifically, the increase in the hardness of the workpiece machined by the drills of the invention ranged from about 190 to 260 in the “FINAL STAGE”, while that of the workpiece machined by the drills Nos. 12-14 as the comparative examples (which were capable of drilling 4000 holes) ranged from 380-455 in the “FINAL STAGE”. That is, it can be said that the increase in the hardness caused by the dills of the invention was smaller than that caused by the drills as the comparative examples, by about 100 or more. Each of the drills Nos. 1-3, having the point angle a of 120°, suffered from chipping at its axially distal end in an early stage of the drilling operation, and accordingly exhibited poor durability and low accuracy in the drilled holes.

After the drilling operations by the drills, internal threads were cut in the holes drilled by the drill No. 6 of the invention and also in the holes drilled by the drill No. 14 as the comparative example, by using a tap. As a result, about 1000 of the holes drilled by the drill No. 14 were tapped by the tap before the tap became incapable. Meanwhile, about 1250 of the holes drilled by the drill No. 6 were successfully tapped by the tap without the tap becoming incapable. This means that the drill of the invention contributes to prolong the service life of the tap by at least 25%.

Another test was conducted by using a drill of the invention (having a point angle α of 130° and a helix angle β of 25°) and a drill as a comparative example (having a point angle α of 140° and a helix angle β of 35°). In this another test, a total of 3200 holes were drilled by each of these drills, and then an amount of increase in hardness of the machined workpiece and a thickness of the hardened surface layer were measured. The amount of increase in the hardness and the thickness of the hardened surface layer in the 3200th hole drilled by the drill of the invention were 162 (HV0.2) and 0.01 mm, respectively. On the hand, those in the 3200th hole drilled by the drill as the comparative example were 405 (HV0.2) and 0.02 mm, respectively. This means that the drill of the invention contributes to reduce the work hardening by about 240 (HV0.2) and to reduce the thickness of the hardened surface layer by half.

While the presently preferred embodiments of the present invention have been illustrated above, it is to be understood that the invention is not limited to the details of the illustrated embodiments, but may be embodied with various other changes, modifications and improvements, which may occur to those skilled in the art, without departing from the spirit and scope of the invention defined in the following claims.

What is claimed is:

1. A drill comprising:
flutes formed therein and extending from an axially distal end portion thereof toward an axially proximal end portion thereof, so as to provide cutting edges in said axially distal end portion,
wherein at least said axially distal end portion is formed of cemented carbide,
wherein said cutting edges cooperate with each other to define a point angle of said drill that is not smaller than 125° and is not larger than 135°,
wherein each of said flutes is twisted by a helix angle that is not smaller than 20° and is not larger than 30°,
and wherein each of said cutting edges has a radially inner end portion which is formed in a web thinning, such that an axial rake angle of said radially inner end portion of each of said cutting edges is not smaller than −5° and is not larger than +5°.

2. The drill according to claim 1, wherein each of said cutting edges is chamfered so as to be provided with a negative land, such that said negative land has a width that is not smaller than 0.05 mm and is not larger than 0.15 mm.

3. The drill according to claim 1, being at least partially coated with a hard coating.

4. A drill which is to be rotated about an axis thereof in a predetermined rotating direction, for drilling a hole in a workpiece, comprising:
primary cutting edges and secondary cutting edges formed in an axially distal end portion thereof such that each of said secondary cutting edges is located on a radially inner side of a corresponding one of said primary cutting edges;
flutes each of which extends from said axially distal end portion toward an axially proximal end portion thereof,
primary rake surfaces each of which defines a corresponding one of said primary cutting edges; and
secondary rake surfaces each of which defines a corresponding one of said secondary cutting edges, such that each of said secondary rake surfaces is located on a radially inner side of a corresponding one of said primary rake surfaces;
wherein at least said axially distal end portion is formed of cemented carbide,
wherein each of said secondary rake surfaces and the corresponding one of said primary rake surfaces are provided by a longitudinally distal end portion of a rear side wall, as viewed in said predetermined rotating direction, of a corresponding one of said flutes,
wherein said primary and secondary cutting edges cooperate with each other to define a point angle of said drill that is not smaller than 125° and is not larger than 135°,
wherein each of said flutes is twisted with respect to said axis by a helix angle that is not smaller than 20° and is not larger than 30°,
and wherein each of said secondary rake surfaces is recessed in such a direction that permits a web thickness in said axially distal end portion to be reduced, such that an axial rake angle of each of said secondary cutting edges is not smaller than −5° and is not larger than +5°.

5. The drill according to claim 4, wherein each of said primary and secondary cutting edges is chamfered so as to be provided with a negative land, such that said negative land has a width that is not smaller than 0.05 mm and is not larger than 0.15 mm.

6. The drill according to claim 4, being at least partially coated with a hard coating.
